(19) United States
(12) Patent Application Publication
(10) Pub. No.: US 2020/0188853 A1
(43) Pub. Date: Jun. 18, 2020

(54) TEMPERATURE-GRADIENT AIDED DIFFUSIOPHORETIC WATER FILTRATION DEVICE

(71) Applicant: Split Rock Filter Systems LLC, New Paltz, NY (US)

(72) Inventor: William C. Gehris, New Paltz, NY (US)

(21) Appl. No.: 16/713,484

(22) Filed: Dec. 13, 2019

Related U.S. Application Data
(60) Provisional application No. 62/779,211, filed on Dec. 13, 2018.

(51) Int. Cl. B01D 63/08; C02F 1/44

(52) U.S. Cl. CPC B01D 63/08; C02F 2101/30; B01D 2313/22; C02F 1/44

(57) ABSTRACT

A water filtration device is provided including a diffusiophoretic water filter having an inlet and an outlet and for receiving a colloidal suspension at the inlet and flowing the colloidal suspension between the inlet and the outlet in a flow direction, a diffusiophoretic-inducing membrane, a cover, the membrane and the cover defining a plurality of channels extending between the inlet and the outlet, an outlet splitter for the plurality of channels being fixed with respect to the membrane or the cover, and a heater or cooler for controlling a temperature of at least one of the colloidal suspension, the membrane or the cover.

This claims the benefit of U.S. Provisional Patent application No. 62/779,211, filed Dec. 13, 2018 and hereby incorporated by reference herein.

U.S. patent application Ser. No. 16/182,579, filed on Nov. 6, 2018 now issued on Nov. 5, 2019 as U.S. Pat. No. 10,463,994 B2 and U.S. patent application Ser. No. 15/861,273, filed on Jan. 3, 2018 now issued on Dec. 18, 2018 as U.S. Pat. No. 10,155,182 B1 and International Patent Application PCT/US18/61146, filed on Nov. 14, 2018, published as WO 2019/099586 on May 23, 2019, all of which of the present assignee are hereby incorporated by reference herein.

### BACKGROUND

The article “Diffusiophoretic exclusion of colloidal particles for continuous water purification” by Lee et al. (Lab on a Chip 2018, 18, 1713), 21 Jun. 2018, describes using two sheets of a NAFION membrane aligned on a glass slide to perform diffusiophoretic exclusion.

WO 2018/048735 discloses a device operative in separating particles in a flowing suspension of the particles in a liquid which device comprises: a first, pressurized cavity or plenum adapted to contain a gas, separated by a first gas permeable wall from a second cavity or plenum which contains a charged particle containing liquid which also contains an ion species formed by the dissolution of the gas within the liquid, which is in turn separated by a second permeable wall from the ambient atmosphere or an optional, third, relatively reduced pressure cavity or plenum which may contain a gas or a vacuum; wherein: the permeable walls operate to permit for the transfer of a gas from the first cavity through the second cavity and through the second permeable wall to the atmosphere or a third cavity and, the pressure present in atmosphere or the third cavity is lesser than that of the first cavity, thus forming an ion concentration differential within the liquid and between the permeable walls.

The related article “Membraneless water filtration using CO2” by Shin et al. (Nature Communications 8:15181), 2 May 2017, describes a continuous flow particle filtration device in which a colloidal suspension flows through a straight channel in a gas permeable material made of polydimethylsiloxane (PDMS). A CO2 (carbon dioxide) gas channel passes parallel to the wall and dissolves into the flow stream. An air channel on the other side of the wall prevents saturation of CO2 in the suspension and the resulting gradient of CO2 causes particles to concentrate on sides of the channel, with negatively charged particles moving toward the air channel and positively charged particles toward the CO2 channel. The water away from the sides of the channel can be collected as filtered water.

The article “Why molecules move along a temperature gradient” by S. Duhr, (Proc Natl Acad Sci USA. 2006 December 26;103(52):19678-82) discusses thermophoresis for various particles.

### SUMMARY OF THE INVENTION

The present invention provides a water filtration device comprising a diffusiophoretic water filter having an inlet and an outlet and for receiving a colloidal suspension at the inlet and flowing the colloidal suspension between the inlet and the outlet in a flow direction; a diffusiophoretic-inducing membrane; a cover, the membrane and the cover defining a plurality of channels extending between the inlet and the outlet; an outlet splitter for the plurality of channels being fixed with respect to the membrane or the cover, and a heater or cooler for controlling a temperature of at least one of the colloidal suspension, the membrane or the cover.

In a preferred embodiment, the cover is heated, for example by wires placed over a PDMS membrane. Cured PDMS such a PDMS membranes available from SSP in Ballston Spa, NY are generally stable to 200 degrees C.

The control of the colloidal suspension temperature can be a function of the temperature of the membrane and/or the temperature of the cover. The control of the colloidal suspension temperature also can be a function of the overall environment temperature.

Preferably, the diffusiophoretic water filter is moving negatively-charged colloidal and even larger particles away from the membrane. Thermophoresis is then used to aid this movement. For example, the temperature of the colloidal suspension at 10 degrees C. and the membrane left unheated, while the cover is heated to 100 degrees C. Particles moving away from the membrane via diffusiophoresis will be aided by thermophoresis and be attracted to heated cover.

The heater can for example be a meandering wire or coil that sits on the cover and aids in clamping the cover to the membrane, while still permitting CO2 or other gas (if a gas-driven diffusiophoretic water filter is being used) to pass through the cover.

The cover heating will increase the temperature of the colloidal suspension only slightly at the channel interface and this increase will depend on various factors such as flow speed, thickness of the cover between the heater and the colloidal suspension, type of cover material used, and the coverage and temperature of the heater.

The method is most preferably used when the colloidal suspension is colder than 20 degrees C., and the temperature of the colloidal suspension at the cover interface at the outlet preferably remains below or approaches 20 degrees C.

When warmer colloidal suspensions are used, for example in areas where the colloidal suspension may be 30 degrees C., cooling of the cover can be provided.

The exact cooling or heating desired will depend on the types of particles desired to be filtered, for example PFOAs or polystyrene beads, and the change in sign of the Soret coefficient.

### BRIEF DESCRIPTION OF THE DRAWINGS

One schematic embodiment of the water filtration system of the present invention is shown by reference to FIG. 1, in which:

FIG. 1 shows a schematic view of an embodiment of a water filtration device system according to the present invention; and

FIG. 2 shows the device in more detail.

### DETAILED DESCRIPTION OF AN EMBODIMENT

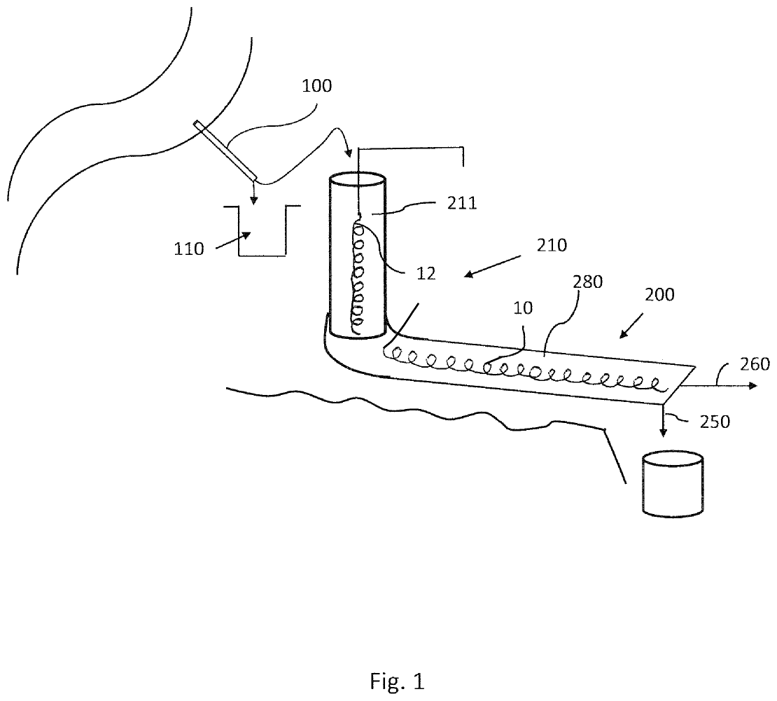

FIG. 1 shows a water filtration system 100 for cleaning river water, which may contain various particles such as colloidal plastic or metallic particles, and other bioparticles such as bacteria and viruses. Many of these particles are charged negatively or positively. Any type of water with charged colloidal particles may be filtered using the present invention. “Colloidal particle” as defined herein is any particle that can form a colloid or colloidal suspension in water. Such colloidal particles typically range in sizes of a micrometer or less, but larger sizes are possible. The present invention is not limited to filtering colloidal particles, but can also be used to filter larger particles that are impacted by diffusiophoresis, for example even up to 100 nanometers in size or larger, from water. Preferably the particles to be filtered are less than 250 nanometers in size, even if not colloidal. These non-colloidal particles can have very low sedimentation rates, and thus the present invention can aid in “sedimentation” or forcing these larger particles downwardly.

Water can be taken by taking water from a river or pond or other source, for example by a hose 100 working via gravity, such as a siphon. The hose 100 delivers water to a first filter 110 to remove larger particles and impurities. First filter 110 can be for example a membrane filter with an absolute pore size of 1 micrometer or 1000 nanometers, for example as commercially available from Brita. Filter 110 also could simply be a settling tank or a sand filter. The water with suspended colloidal particles, i.e. a colloidal suspension, together with possible other particles that are larger than typical colloidal sizes, then passes to the water filtration device 200 of the present invention.

Water filtration device 200 is designed to remove negatively charged colloidal particles and other particles, the removal of which can significantly increase the water quality, and clean water can exit from the bottom of the device at a clean water stream 250, and waste water can be discarded at stream 260.

A heater or cooler 12 can be provided upstream of the water filter 280, for example in inlet manifold 210. A cover heater or cooler 10 can be laid on or integral within a cover of water filter 220.

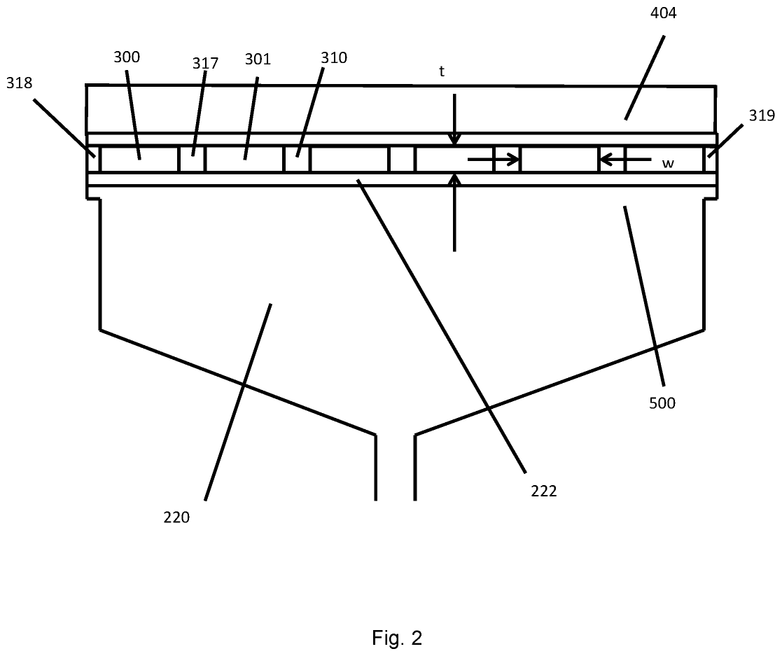

A gas driven diffusiophoretic water filter, shown in FIG. 2 schematically in cross section, has a gas permeable membrane 222 over a gas chamber 220 and a gas permeable cover 310. Tapes 317, 318, 319 define with the membrane 222 and cover 310 channels with a width W and a thickness t.

A gas permeable heater or cooler 404, for example an electrically-heated metal honeycomb structure, can sit over membrane 310 and also aid in preventing bulging.

A gas permable heater or cooler 500 can sit in chamber 220, for example against membrane 222.

What is claimed is:

1. A water filtration device comprising a diffusiophoretic water filter having an inlet and an outlet and for receiving a colloidal suspension at the inlet and flowing the colloidal suspension between the inlet and the outlet in a flow direction; a diffusiophoretic-inducing membrane; a cover, the membrane and the cover defining a plurality of channels extending between the inlet and the outlet; an outlet splitter for the plurality of channels being fixed with respect to the membrane or the cover, and a heater or cooler for controlling a temperature of at least one of the colloidal suspension, the membrane or the cover.

2. A method for operating a diffusiophoretic water filter comprising heating or cooling a colloidal suspension, upstream of the filter, or at a cover or diffusiophoretic-inducing membrane.

3. A method for aiding diffusiophoretic motion of a particle by inducing a temperature gradient on the particle to move it in a same direction as the diffusiophoretic motion.
